(19) United States
(12) Patent Application Publication
(10) Pub. No.: US 2017/0373501 A1
(43) Pub. Date: Dec. 28, 2017

(54) POWER GENERATION SYSTEM, POWER GENERATION CONTROL METHOD AND PROGRAM

(71) Applicant: NEC Corporation, Tokyo (JP)

(72) Inventor: Yasuharu OKAMOTO, Tokyo (JP)

(73) Assignee: NEC Corporation, Tokyo (JP)

(21) Appl. No.: 15/544,500

(22) PCT Filed: Dec. 10, 2015
(86) PCT No.: PCT/JP2015/084630

§ 371 Date: Jul. 18, 2017

(30) Foreign Application Priority Data
Jan. 21, 2015 (JP) 2015-009184

(51) Int. Cl. H02J 3/32; H02J 7/04

(52) U.S. Cl. CPC H02J 3/32; H02J 7/04

(57) ABSTRACT

A power generation system of the invention includes: generator (11), secondary battery (12) and control unit (13). The control unit (13) discharges secondary battery (12) to supply electric power from secondary battery (12) to load (20) when the state of charge of secondary battery (12) has reached the upper limit capacity, activates generator (11) so as to supply part of the power from the generator to load (20) while charging secondary battery (12) with surplus power when the state of charge reaches the lower limit capacity, and stops generator (11) and switches the power supply source for load (20) from generator (11) to secondary battery (12) when the state of charge reaches the upper limit capacity, whereby the control unit keeps generator (11) at the maximum power generation efficiency or at the rated output when generator (11) is being operated.

### TECHNICAL FIELD

The invention relates to a power generation system including a generator and a secondary battery, a power generation control method and a program that causes a computer to implement carry out the method.

### BACKGROUND ART

Recently, in order to achieve stable energy supply and improved usage efficiency of energy, decentralized power generation systems have drawn a great deal of attention. In the decentralized power generation system, it is possible to build redundancy into the power grid by generating electricity using gas and/or light oil as fuel, and hence contribute to a stable energy supply especially when the power grid is shut down. When methane gas that is given off in a biomass system or during sewage sludge treatment is used as fuel, methane gas can be used as a its own energy source, hence is useful to supply energy stably in a local area. Further, since the decentralized power generation system is installed close to consumption areas, it is possible to reduce power loss during power transmission in a centralized electric power system, which is estimated as high as 5%. Moreover, it is possible to improve the total energy efficiency up to as high as 80% by making use of a heat and electricity combined system that not only uses electricity but also heat exhausted during generation of electricity to create steam or hot water from water. This makes it possible to reduce the amount of primary energy (fuel) that is used and also to contribute to low carbon operation.

Solar power generation and wind power generation are also important decentralized power generation technologies. From the standpoint of running cost, the advantage of solar power generation and wind power generation is that fuel is not needed. However, because these power generation systems depend on climate and weather, they are not capable of supplying a continuous and stable source of electricity, therefore, from the point of view of having a stable power supply, thermal power generation and fuel cells that use fuel have a greater advantage. In particular, in a system called a micro grid that supplies most of electricity for local areas and facilities by enhancing independency from the power grid, it is impossible to construct an energy system mainly based on solar power generation or wind power generation without using a large-scale secondary battery system.

In a power generation system using fuel, the fuel cost occupies about 80% in the total cost which consists of initial construction costs, maintenance costs and fuel itself (see Non-patent Document 1). Therefore, reducing fuel consumption improves economic efficiency and also contributes to low-carbon operation, hence is important.

However, the power generation efficiency of the generator in a decentralized power generation system is, for example, as low as 35% in a small-scale generator except for fuel batteries (which have a power generation efficiency of 40 to 50%), hence is considerably low compared to a large-scale generator for power grids (having a power generation efficiency of 40 to 60%). That is, power generator in a decentralized power generation system has low fuel efficiency. In general, generators are designed to run most efficiently at their rated output. When, in the decentralized power generation system, the generator is operated to satisfy the load or power demand requirement, if the generator is kept running at a low output state off the rated output condition, the power generation efficiency is significantly lowered.

To deal with this, there is a system in which multiple small power generators are used instead of a single high power generator (see Non-patent Document 2) when such a decentralized power generation system is operated in the load following mode in power plants.

On the other hand, one example of technologies aimed at reducing an increasing power that a power supply system must provide including in Patent Document 1. Patent Document 1 discloses a power supply system including a fuel battery and secondary battery, when the load demands low power from the fuel battery, the fuel battery power is used for consumption at the load and charging of the secondary battery, when the load demands high power from the fuel battery, the fuel battery power and the secondary battery power is supplied to the load.

### PRIOR ART DOCUMENTS

### Patent Documents

Patent Document 1: JP Hei-10-040931A

### Non-Patent Documents

Non-patent Document 1: “Cogeneration Basic Data Collection” [online], September 2012, The Agency for Natural Resources and Energy in the Ministry of Economy, Trade and Industry, [Search on Jan. 5, 2015] Internet <URL: http://www.enecho.meti.go.jp/category/electricity_and_gas/other/cogeneration/pdf/1-1.p df>

Non-patent Document 2: “Multiple Unit Supporting System” [online], Yanmer Co., Ltd., [Search on Jan. 5, 2015] Internet <URL: https://www.yanmar.com/jp/energy/normal generator/cp/about/multiple.html>

### SUMMARY OF THE INVENTION

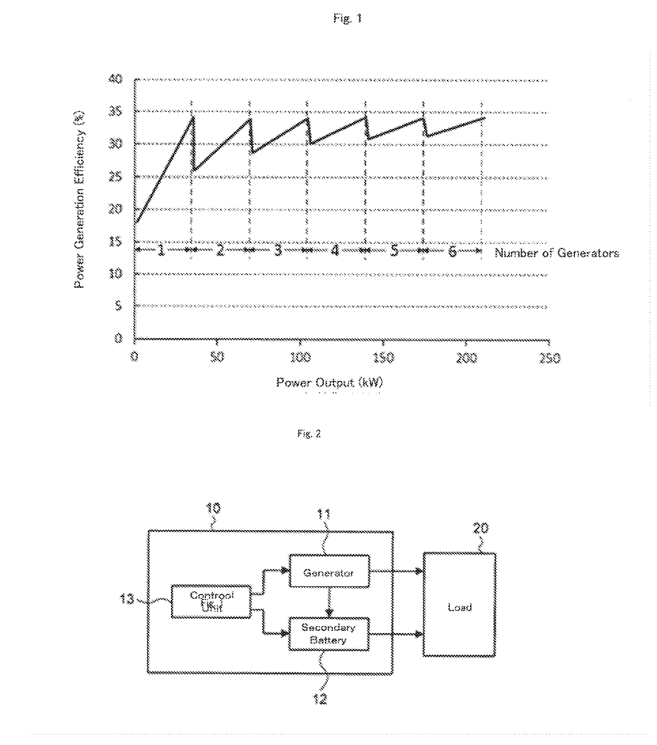

However, in the method disclosed in Non-patent Document 2, the possibility exists that the utilization ratio of the generators operated to cope with peak demand become lower, depending upon the power demand pattern, hence causing performance degradation. This performance degradation gives rise to a problem especially when a relatively lower number of generators are operated. This problem will be described with reference to FIG. 1.

FIG. 1 shows variations in electric power generation efficiency with respect to the total power output when, at the maximum, six identical generators having a rated output of 35 kW are operated. Each generator is set so that the power generation efficiency takes 18% as a limiting value at zero output and linearly rises to 34% at maximum at the rated output. When the electric power output for load power demand is a multiple of 35 kW, each generator generates power at the maximum efficiency, so that the total power generation efficiency becomes maximum. However, when the generators are operated in the load following mode in power plants, the load power demand cannot continuously coincide with the rated output of the generators. When the generators take a partial load state off the rated value, the power efficiency lowers. Referring to FIG. 1, the amount of drop in efficiency is found to become conspicuous when a lower number of generators are operated.

It should be noted that the invention disclosed in Patent Document 1 is aimed at solving a problem different from the above.

It is an object of the present invention to provide a power generation system that can keep generators at high power generation efficiency even if load power demand is not constant.

The power generation system according to one aspect of the present invention includes: a generator connected to a load; a secondary battery connected to the generator and the load; a control unit that discharges the secondary battery to supply electric power from the secondary battery to the load when the state of charge of the secondary battery has reached the upper limit capacity, activates the generator so as to supply part of the power from the generator to the load while charging the secondary battery with surplus power when the state of charge reaches the lower limit capacity, and stops the generator and switches the power supply source for the load from the generator to the secondary battery when the state of charge reaches the upper limit capacity, wherein the control unit keeps the generator at the maximum power generation efficiency or at the rated output when the generator is being operated.

The power generation control method according to one aspect of the invention is a power generation control method in a power generation system including: a generator connected to a load; a secondary battery connected to the generator and the load; a control unit controlling the generator and the secondary battery, comprising the steps of: discharging the secondary battery to supply electric power from the secondary battery to the load when the state of charge of the secondary battery has reached the upper limit capacity; activating the generator so as to supply part of the power from the generator to the load while charging the secondary battery with surplus power when the state of charge reaches the lower limit capacity; stopping the generator and switching the power supply source for the load from the generator to the secondary battery when the state of charge reaches the upper limit capacity; and, keeping the generator at the maximum power generation efficiency or at the rated output when the generator is being operated.

The program according to one aspect of the invention causes a computer for controlling a generator connected to a load and a secondary battery connected to the generator and the load to execute: a step of discharging the secondary battery to supply electric power from the secondary battery to the load when the state of charge of the secondary battery has reached the upper limit capacity; a step of activating the generator so as to supply part of the power from the generator to the load while charging the secondary battery with surplus power when the state of charge reaches the lower limit capacity; a step of stopping the generator and switching the power supply source for the load from the generator to the secondary battery when the state of charge reaches the upper limit capacity; and, a step of keeping the generator at the maximum power generation efficiency or at the rated output when the generator is being operated.

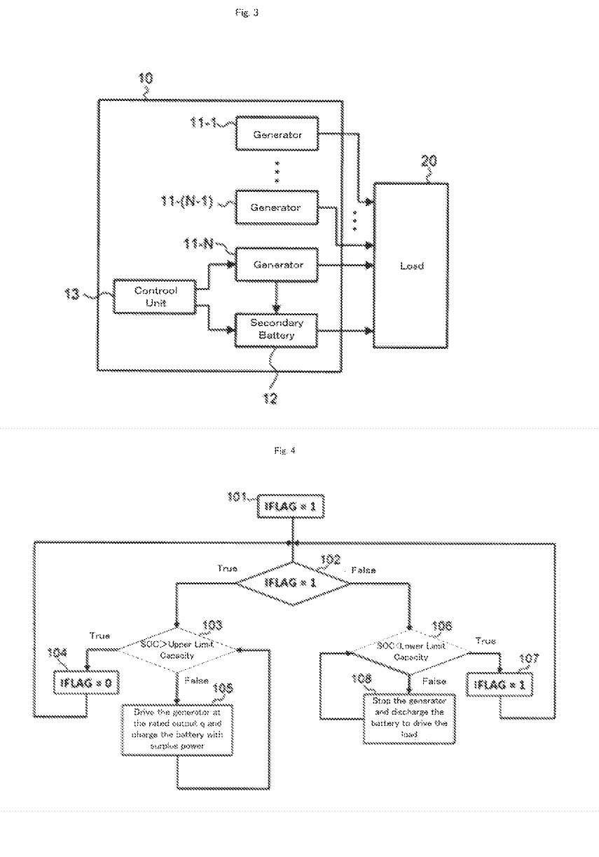

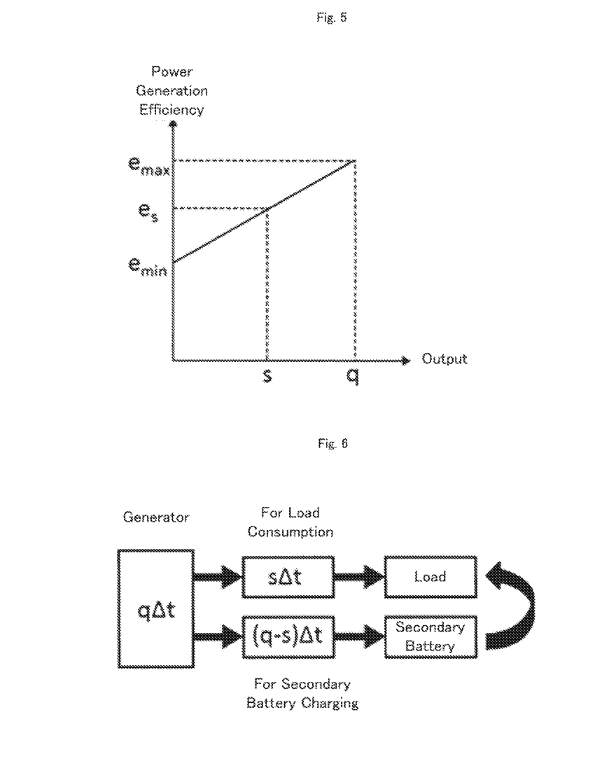

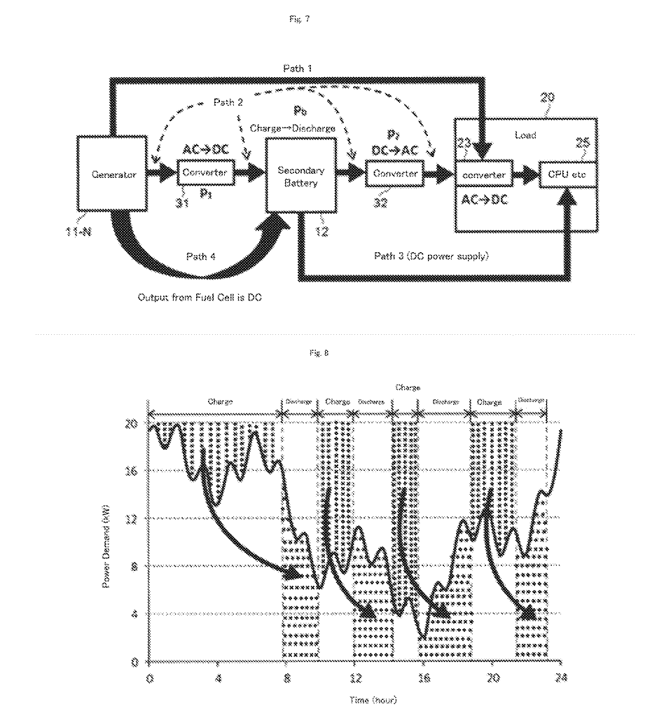

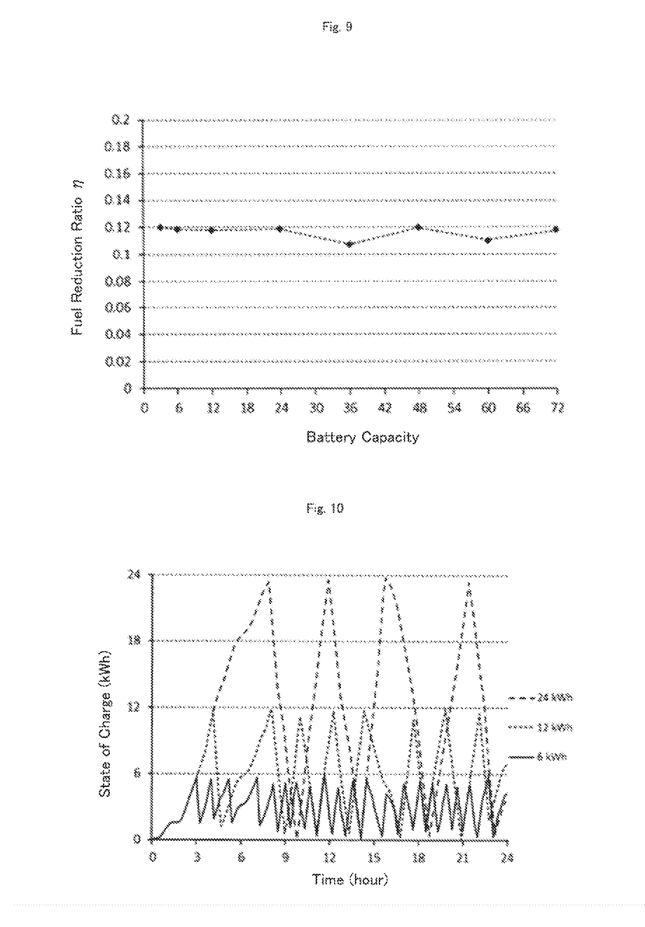

### BRIEF DESCRIPTION OF THE DRAWINGS

[FIG. 1] A diagram showing a relationship between the output and the power generation efficiency in a power generation system including multiple generators.

[FIG. 2] A block diagram showing one configurational example of a power generation system of the present exemplary embodiment.

[FIG. 3] A block diagram showing another configurational example of a power generation system of the present exemplary embodiment.

[FIG. 4] A flow chart showing operational procedures of a power generation system of the present exemplary embodiment.

[FIG. 5] A graph showing the relationship between the output of a generator used in the power generation system of the present embodiment and the power generation efficiency.

[FIG. 6] A schematic diagram for illustrating the operation of a power generation system of the present exemplary embodiment.

[FIG. 7] A schematic diagram showing an energy converting process in one configurational example of a power generation system of the present exemplary embodiment.

[FIG. 8] A diagram showing a relationship of the switching of operation modes along with a sample path of the time-dependent power demand in the power generation of the present exemplary embodiment.

[FIG. 9] A diagram showing the relationship between the capacity of secondary batteries and the fuel consumption reduction ratio achieved by the power generation.

[FIG. 10] A diagram showing the relationship between the time-dependent behavior of the state of charge and the capacity of secondary batteries.

### MODE FOR CARRYING OUT THE INVENTION

The configuration of a power generation system of the present exemplary embodiment will be described. FIG. 2 is a block diagram showing one configurational example of a power generation system of the present exemplary embodiment.

As shown in FIG. 2, power generation system 10 of the present exemplary embodiment includes generator 11, secondary battery 12 and control unit 13. The output side of generator 11 is connected to secondary battery 12 and load 20 in such a manner that connection is switchable between secondary battery 12 and load 20. The output side of second battery 12 is connected to load 20.

Control unit 13 includes a memory (not illustrated) storing programs and a CPU (Central Processing Unit) executing processes in accordance with the programs. The memory of the upper limit capacity and the lower limit capacity of the state of charge of secondary battery 12 has been previously registered in control unit 13.

Control unit 13 monitors the state of charge of secondary battery 12, and discharges secondary battery 12 to supply electric power to load 20 when the state of charge of secondary battery 12 has reached the upper limit capacity. When the state of charge of secondary battery 12 reaches the lower limit capacity, control unit 13 activates generator 11 and keeps its output at the rated output to supply part of power generated by generator 11 to load 20 and surplus power to secondary battery 12. When the state of charge of secondary battery 12 reaches the upper limit capacity, control unit 13 stops generator 11 and switches the power source to load 20 from generator 11 to secondary battery 12.

Here, in operating generator 11, control unit 13 can drive generator 11 at the maximum power efficiency.

FIG. 3 is a block diagram showing another configurational example of a power generation system of the present exemplary embodiment.

The power generation system 10 shown in FIG. 3 further includes, N (N is an integer greater than 1) generators 11-1 to 11-N, in addition to secondary battery 12 and control unit 13 shown in FIG. 2. In this case, generators 11-1 to 11-(N-1) supply power to load 20 at the rated output. Also in the power generation system shown in FIG. 3, control unit 3 may and should control generator 11-N and secondary battery 12 in the same manner as in the power generation system shown in FIG. 2.

The power generation system of the present exemplary embodiment will be described in detail by comparison with the power generation system shown in FIG. 1. In comparison with the power generation system shown in FIG. 1, the following description will be made on a case of the power generation system (including N generators 11) shown in FIG. 3.

The operation form of the power generation system configured with multiple identical generators, described with reference to FIG. 1, can be considered as follows:

When a multiple number of generators having a rated output of q kW are used to produce a total output of p kW to cope with power demand of load, int (p/q) generators are driven to generate the rated power, i.e., q. Here, int (x) is a function representing the integer part of x. Further, one generator is driven in a partial load state to produce an output of {p−q×int(p/q)}. Accordingly, with N=int (p/q)+1, (N-1) generators are operated at the maximum power efficiency while the remaining one is driven in a partial load state with a low efficiency. If the number of generators being operated is large enough, the last one operated at the partial load state makes a relatively small contribution, so that a relatively high power generation efficiency can be expected.

However, when N is not so large, efficiency reduction due to the generator being operated at a partial load state cannot be disregarded. In this case, it can also be argued that N can be made greater by making q smaller (in other words, using generators of a lower output). In reality, since the maximum power generation efficiency eₘₐₓ of a generator depends on rated output q, if q is set at a small value, eₘₐₓ itself also becomes lowers. As a result, the total power generation efficiency is not always improved. This means that different innovative approach is needed.

In the power generation system comprised of N generators, since it is possible to set (N-1) generators at the rated output or suspend part of the generators when the number of generators is in excess to cope with power demand, only a single generator resides in a partial load state. Therefore, the following description will be given by focusing on this single generator being operated at a partial load state. In the configurational example shown in FIG. 3, generator 11-N is the subject.

Herein, this generator will be regarded as being driven by force at the rated output and any surplus power that, at that point, exceeds the power demand will be used for charging secondary battery 12. When the state of charge (SOC: State Of Charge) of the secondary battery reaches the upper limit capacity, the generator is stopped and discharge from the secondary battery is allotted to power demand. When the SOC of the secondary battery reaches the lower limit capacity, the generator is restarted at rated output q and surplus power is directed to charge the secondary battery. From that point forward, this loop will be repeated to operate the power generation system. FIG. 4 is a flow chart showing this operation of the power generation system.

The operation of the power generation system of the present exemplary embodiment will be described with reference to FIG. 4.

Control unit 13, in response to whether or not the state of charge of secondary battery 12 is equal to or higher than the lower limit capacity, records a value of “IFLAG” representing information for either charging or discharging secondary battery 12, into the memory (not shown) in the control unit. IFLAG=1 corresponds to the charging of secondary battery 12, whereas IFLAG=0 corresponds to the discharging of secondary battery 12. Control unit 13 periodically monitors secondary battery 12 and records the result into the memory (not shown) in the control unit.

In the initial state, IFLAG=1 has been recorded in the memory (not shown) (Step 101). Control unit 13 determines whether or not IFLAG=1 is true (Step 102). If the result of determination is true, the control unit determines whether the state of charge of secondary battery 12 is higher than the upper limit capacity (Step 103).

When the determination result at Step 103 is true, control unit 13 rewrites the IFLAG value from 1 to 0 and returns control to Step 102. When the determination result at Step 103 is false, control unit 13 drives generator 11-N at rated output q and charges secondary battery 12 with surplus power (Step 105). After Step 105, control unit 13 returns control to the determination at Step 103.

On the other hand, when the determination result at Step 102 is false, the control unit determines whether or not the state of charge of secondary battery 12 is lower than the lower limit capacity (Step 106). When the determination result at Step 106 is true, control unit 13 rewrites the IFLAG value from 0 to 1 and returns control to Step 102. When the determination result at Step 106 is false, control unit 13 suspends generator 11-N and discharges secondary battery 12 to drive load 20 with power from secondary battery 12.

Use of the above method in the present embodiment makes it possible to drive all the working generators at the rated output. FIG. 5 shows one example of a specific model of a generator used in the present exemplary embodiment. Considered in the present exemplary embodiment is a generator that presents power generation efficiency taking maximum value eₘₐₓ at rated output q and eₘᵢₙ as the limiting value at zero output, as shown in FIG. 5. Further, the relation between the output and the power generation efficiency can be approximated with a linear function. With this, power generation efficiency eₛ at power output s(0<s<q) can be represented by the following equation:

$${e}_{s} = \frac{( {e}_{ma x} - {e}_{m i n} )}{q} s + {e}_{m i n} \qquad Eq . ( 1 )$$

The operation of the power generation system of the present exemplary embodiment will be described with reference to the schematic diagram shown in FIG. 6.

In the power generation system shown in FIG. 6, when the generator is driven at rated output q, of electric energy qΔt generated during time Δt, sΔt is consumed while the load (q-s)Δt is stored as surplus energy into the secondary battery. Herein, for description convenience, the loss accompanied by AC-DC conversion and energy conversion in charging and discharging in the battery was assumed to be zero. When F_{q} represents the fuel required for generating electric energy (qΔt) at rated output q in time Δt, F_{q} is represented by the following equation.

$${F}_{q} = \frac{q Δ t}{{e}_{ma x}} \qquad Eq . ( 2 )$$

Similarly to rated output q, when Fₛ represents the fuel required for generating the same electric energy (qΔt) by power output s, Fₛ is represented by the following equation.

$${F}_{s} = \frac{q Δ t}{{e}_{s}} \qquad Eq . ( 3 )$$

From Eq. (2) and Eq. (3), reduction in the amount of fuel by keeping the rated output is represented by Fₛ-F_{q}. The ratio of this to Fₛ represents fuel reduction ratio (η).

$$η = 1 - \frac{{F}_{q}}{{F}_{s}} \qquad Eq . ( 4 )$$

In the power generation system of the present exemplary embodiment has been invented based on the result of study on these.

The system using generators with a secondary battery is considered to entail the following problems:

(i) energy loss takes place due to an increased number of times of DC-AC conversion because the battery is used as the intermediary; and,

(ii) there is a possibility that the battery life may be shorted due to the increased number of charge/discharge cycles.

Of the above (i) and (ii), the problem (i) will be described first.

FIG. 7 is a schematic diagram showing an energy converting process in one configurational example of a power generation system of the present exemplary embodiment. In FIG. 7, the loss in conversion of the output from the generator and secondary battery, “AC to DC” and “DC to AC”, is taken into account.

The system configuration example shown in FIG. 7 has converter 31 arranged between generator 11-N and secondary battery 12 and converter 32 arranged between secondary battery 12 and load 20. Converter 31 converts the AC output from generator 11-N to DC power to be output to load 20. The conversion efficiency of converter 31 is denoted by p₁ and the conversion efficiency of converter 32 is denoted by p₂. The efficiency of charging and discharging in secondary battery 12 is denoted by p_{b}.

In the system configuration example shown in FIG. 7, load 20 includes device 25 such as a CPU or the like that operates on DC voltage and converter 23 that converts power supplied from the outside, from AC to DC to supply device 25.

The output from the generator is usually AC. Path 1 shown in FIG. 7 shows a case in which the AC output from generator 11-N is directly supplied as is to load 20. On the other hand, path 2 shown in FIG. 7 shows a case in which the output from generator 11-N is supplied to load 20 by way of secondary battery 12. In comparison with path 1, path 2 undergoes three conversion stages, specifically, AC to DC conversion (with a conversion efficiency of p₁), battery charging and discharging (with an efficiency of p_{b}) and DC to AC conversion (with a conversion efficiency of p₂), hence path 2 undergoes an energy loss ratio of eₗₒₛₛ=1-p_{ef}. Here, p_{ef}=p₁ p₂ p_{b}.

Reduction ratio η of fuel consumption in this power generation system is approximately represented by the following equation.

$$η = 1 - \frac{{F}_{q}}{{F}_{s}} \approx 1 - ( \frac{{e}_{av}}{{e}_{ma x}} \times \frac{q}{{d}_{av} + ( q - {d}_{av} ) {p}_{ef}} ) \qquad Eq . ( 5 )$$

In Eq. (5), eₐᵥ is the estimated value of the average power generation efficiency of the generator when the generator is operated alone without any battery. Denoted at dₐᵥ is the estimated value of average power demand, and p_{ef} the estimated value of energy conversion efficiency. As the energy conversion efficiency becomes lower so does p_{ef}, and it is possible that η will take a negative value. In such a circumstance, the case in which power from the generator is output by way of the battery consumes a greater amount of fuel than the case where the generator is directly connected to the load. Therefore, choice of the path via the battery is suitable only when i in the above equation is not negative. Accordingly, control unit 13 preferably switches operation modes while the system is operating by monitoring the estimated value η calculated by Eq. (5).

In a situation in which the relation between the power generation efficiency and the output of the generator is represented by a linear function, when there is a power demand of s₁ fuel consumption will never decrease by driving the generator at the high output state while flows through the resistor or others instead of charging surplus power (s₂-s₁), where the efficiency at low output state s₁ is denoted by e₁ and the efficiency at high output state s₂ is denoted by e₂. The reason is that if the fuel consumption becomes lower at the high output state than the low output state the following equation needs to hold.

$$\frac{{s}_{2}}{{e}_{2}} < \frac{{s}_{1}}{{e}_{1}} \qquad Eq . ( 6 )$$

When the relation between the power efficiency and the power output is given by a linear function, s₁>s₂ holds from the inequality of Eq. (6) while s₂>s₁ also holds by definition of high power output and low power output. This results in a contradiction, hence fuel consumption will never decrease without charging the battery. On the contrary, when the relation between the power generation efficiency and the power output is not given by a linear function, it could occur that fuel consumption can be reduced by driving the generator at the high output operation while wasting surplus power because current flows through the resistor and others without use of the battery.

Next, the problem (ii) will be explained.

The basic solution to the problem (ii) is to increase battery capacity by reducing the number of charge/discharge cycles. In the following example 3, it is possible to reduce the number of cycles to 4 cycles/day by appropriate choice of the battery capacity. A somewhat large scale battery has the advantage of also being used for business continuity planning (BCP: Business Continuity Planning) purposes. However, since the greater the battery capacity, the higher the cost, it is necessary to consider balance between the number of cycles and suitable cost. In view of reducing battery deterioration, it is possible to construct a system in which charging and discharging are repeated at short intervals when the SOC reaches a level that would reduce degradation. However, since in this power generation system the generator is stopped during discharge, frequent activation and deactivation of the generator leads to startup loss and deterioration of the generator itself so that the operation mode of this kind is not preferable.

Fundamental measures against the problem (ii) may include: use of DC supply such as path 3 in which load CPU and other devices are directly driven by DC output from the battery; and combination of generating equipment such as fuel cells and others that originally supply DC output as in path 4.

Next, specific examples of the above-described power generation system will be described.

### EXAMPLE 1

<Effect of Reduction in Fuel Consumption by the Power Generation System of the Present Exemplary Embodiment>

FIG. 8 is a diagram showing a relationship of the switching of operation modes along with a sample path of the time-dependent power demand in the power generation system of the present exemplary embodiment. In the present exemplary embodiment, description will be made on the result of the effect of reduction in fuel consumption by the power generation system of the present exemplary embodiment when the power demand in one day is represented by the thick solid line in FIG. 8.

Since the peak value of power demand was 20 kWh, the rated output q of the generator was also set at 20W kWh. The generator has a maximum power generation efficiency of 34% and a minimum power generation efficiency of 18% while the battery has a capacity of 24 kWh. AC to DC conversion efficiency (p₁), battery's charge/discharge efficiency (p_{b}) and DC to AC conversion efficiency (p₂) are all assumed to be 0.95.

When the system starts from a state with battery residual at zero, the generator is kept driven at rated output 7 or 8 hours from the start, and surplus power, the amount of power generation minus demand (the part indicated by the vertical dashed lines in the drawing) is stored into the battery. When the battery reaches full charge, the generator is stopped and battery discharge provides the necessary power demand (the part indicated by the transversal dashed lines) for driving the load. Further, as discharge from the battery continues forward so that the residual capacity reaches zero, the generator starts operating again to generate the rated output and supply and charge surplus power to the battery. In this way, the power generation system of the present exemplary embodiment is operated so as to repeat the charging and discharging of the secondary battery (and activation and suspension of the generator). In the example shown in FIG. 8, reduction ratio η of the fuel consumption by the power generation system of the present exemplary embodiment was 11.9% in comparison to the case when power demand was dealt with by the generator alone.

### EXAMPLE 2

<Dependency of the Effect of Reduction in Fuel Consumption on the Capacity of the Secondary Battery>

This example explains that the effect of reduction in fuel consumption based on the present exemplary embodiment is not dependent on the capacity of the secondary battery. FIG. 9 shows variations of reduction ratio η of fuel consumption when the battery capacity alone was changed in the range of from 3 to 72 kWh under the same conditions with example 1. Referring FIG. 9, reduction ratio η takes a value around 0.12, hence does not strongly depend on the battery capacity. This reduction ratio η is approximately represented by the following equation.

$$η = 1 - \frac{{F}_{q}}{{F}_{s}} \approx 1 - ( \frac{{e}_{av}}{{e}_{ma x}} \times \frac{q}{{d}_{av} + ( q - {d}_{av} ) {p}_{ef}} ) \qquad Eq . ( 7 )$$

In Eq. (7), eₐᵥ denotes the average power generation efficiency of the generator when the generator is operated alone without using any battery. Denoted at dₐᵥ is the average power demand, and p_{ef} denotes energy conversion efficiency. For example, when AC power output from the generator is charged to the secondary battery and then power is discharged from the battery and converted to AC to drive the load, p_{ef} is represented by the product of AC-to-DC conversion efficiency, battery charge/discharge efficiency and DC-to-AC conversion efficiency.

Since Eq. (7) does not contain information related to the capacity of the secondary battery, it is understood that the reduction ratio does not approximately depend on the battery capacity. In the current example, the approximate value of η from the right side of the above equation is 0.146, which is close to the value in FIG. 9.

### EXAMPLE 3

<Relationship Between Battery Capacity and the Number of Charge/Discharge Cycles>

In the present exemplary embodiment, as shown in example 2 the effect of reduction in fuel consumption does not depend on the capacity of the secondary battery. Since batteries of large capacity are expensive, small sized batteries is preferable. However, when the capacity is small, the number of charge/discharge cycles increases, causing a risk that the battery's life will be shortened.

FIG. 10 shows time variation of the state of charge (SOC) when the battery capacity is changed or set at 6 kWh, 12 kWh and 24 kWh. Referring to FIG. 10, when the battery capacity is 6 kWh, the number of charge/discharge cycles is 20 cycles/day. On the other hand, with battery capacities 12 kWh and 24 kWh, the numbers of charge/discharge cycles are 8 cycles/day and 4 cycles/day, respectively.

Basically, the number of cycles is considered to be inversely proportional to the capacity. However, batteries that have a low capacity require a greater number of cycles than that estimated by this relationship, hence there is a concern that the battery's life may be further shortened. Besides, because frequent repetition of activation and suspension of the generator causes problems such as startup loss and other harmful influences, it is hence necessary to avoid the generator being repeatedly activated and suspended in a short period of time as much as possible. In this example, use of a battery having a capacity of one-tenth of the power consumption per day can reduce the number of charge/discharge cycles to as low as 4 cycles/day, which is preferable.

In the power generation system of the present exemplary embodiment, the generator is operated under conditions such as the rated output so as to be able to achieve high power generation efficiency while surplus power generated thereby is used for charging the secondary battery. Then, when the state of charge of the secondary battery reaches the upper limit capacity, the generator is stopped and the secondary battery is discharged instead so that power from the secondary battery can handle the power demand of the load. Further, as the state of charge of the secondary battery reaches the lower limit capacity as a result of discharge, the generator is restarted so that power supply to the load is switched from the secondary battery to the generator while surplus power is supplied to charge the secondary battery.

Repeating the above-described operation makes it possible to keep the generator in a state with high power generation efficiency and hence achieve improved fuel usage efficiency even when the load demands power corresponding to a partial load state in which the generator cannot generate power at high efficiency. As a result, fuel consumption can be reduced not only to lower user's fuel expenses but also to contribute to the improvement of global environments by reducing carbon dioxide emission.

Further, it is possible in a power generation system having multiple generators to keep the generators operating at high power efficiency even in a case where partial load state continues as a result of an operation mode such as load following mode.

One example of the effect of the present invention will be described. According to the present invention, it is possible to keep the generator operating in a state of high power generation efficiency even in a condition where load power demand is not constant.

A program for causing a computer execute the power generation control method described in the exemplary embodiment may be stored in a computer-readable recording medium. In this case, by installing the program from the recording medium to another information processing device, it is possible to make the information processing device execute the above-described information processing method.

Although the present invention has been explained with reference to the exemplary embodiments, the present invention should not be limited to the above exemplary embodiments. Various modifications that can be understood by those skilled in the art may be made to the structures and details of the present invention within the scope of the present invention.

### INDUSTRIAL APPLICABILITY

The present invention can be applied to a power generation system that usually can only be operated at low power generation efficiency because power requires partial load state. The present invention can not only be applied to large-scale decentralized power generation systems but also to relatively small-scale decentralized power generation systems.

This application claims priority based on Japanese Patent Application 2015-009184 filed on Jan. 21, 2015, and incorporates all the disclosure thereof herein.

### DESCRIPTION OF REFERENCE NUMERALS

10 power generation system
11, 11-1 to 11-N generator
12 secondary battery
13 control unit

1. A power generation system comprising:
a generator connected to a load;
a secondary battery connected to the generator and the load;
a control unit that discharges the secondary battery to supply electric power from the secondary battery to the load when the state of charge of the secondary battery has reached the upper limit capacity, activates the generator so as to supply part of the power from the generator to the load while charging the secondary battery with surplus power when the state of charge reaches the lower limit capacity, and stops the generator and switches the power supply source for the load from the generator to the secondary battery when the state of charge reaches the upper limit capacity,
wherein the control unit keeps the generator at the maximum power generation efficiency or at the rated output when the generator is being operated.

2. The power generation system according to claim 1, further comprising:
a first converter provided between the generator and the secondary battery and converting AC output from the generator to DC power to be output to the secondary battery; and,
a second converter provided between the secondary battery and the load and converting DC output from the secondary battery to AC power to be output to the load,
wherein the control unit, based on the average power generation efficiency of the generator, the average power demand of the load, the conversion efficiency ratios of the first and second converters and the estimated value of the charge/discharge efficiency of the secondary battery, determines whether or not the surplus power is to be applied to the charging of the secondary battery.

3. The power generation system according to claim 1, wherein the power generation efficiency of the generator is represented as a positive slope linear function of the power generation output.

4. A power generation control method in a power generation system including: a generator connected to a load; a secondary battery connected to the generator and the load; a control unit controlling the generator and the secondary battery, comprising the steps of:
discharging the secondary battery to supply electric power from the secondary battery to the load when the state of charge of the secondary battery has reached the upper limit capacity; activating the generator so as to supply part of the power from the generator to the load while charging the secondary battery with surplus power when the state of charge reaches the lower limit capacity;
stopping the generator and switching the power supply source for the load from the generator to the secondary battery when the state of charge reaches the upper limit capacity; and,
keeping the generator at the maximum power generation efficiency or at the rated output when the generator is being operated.

5. A computer-readable recording medium recorded with a program that causes a computer for controlling a generator connected to a load and a secondary battery connected to the generator and the load to execute:
a step of discharging the secondary battery to supply electric power from the secondary battery to the load when the state of charge of the secondary battery has reached the upper limit capacity;
a step of activating the generator so as to supply part of the power from the generator to the load while charging the secondary battery with surplus power when the state of charge reaches the lower limit capacity;
a step of stopping the generator and switching the power supply source for the load from the generator to the secondary battery when the state of charge reaches the upper limit capacity; and,
a step of keeping the generator at the maximum power generation efficiency or at the rated output when the generator is being operated.
